(19) United States
(12) Patent Application Publication
(10) Pub. No.: US 2002/0057958 A1
(43) Pub. Date: May 16, 2002

(54) Placement element release device for multiple placement element belts and release system for placement elements

(76) Inventors: Friedrich Eschenweck, Feldkirchen (DE); Michael Schwiefert, Muenchen (DE); Thomas Liebeke, Kolbermoor (DE); Alexander Worzischek, Neuried (DE)

Correspondence Address: STAAS & HALSEY LLP, 700 11TH STREET, NW, SUITE 500, WASHINGTON, DC, 20001, US

(21) Appl. No.: 09/912,259

(22) Filed: Jul. 25, 2001

(30) Foreign Application Priority Data
Nov. 14, 2000 (DE) 10056326.0

(51) Int. Cl. B65G 65/30

(52) U.S. Cl. 414/403; 414/416.03

(57) ABSTRACT

Placement element release device and release system for placement elements having at least one multiple placement element belt which has, transversely with respect to its transport direction at least two tracks along which placement elements are arranged in openings. A transport apparatus is provided, by which the multiple placement element belt can be transported in the transport direction and the openings can be positioned in a collection position. In this case, in the collection position a plurality of placement elements corresponding to the number of tracks are arranged next to one another transversely with respect to the transport direction, and, in the region of the collection position, a screen which can be displaced relative to the placement elements is arranged above the multiple placement element belt in such a way that the placement elements can be covered, and can be released by the screen.

### CROSS REFERENCE TO RELATED APPLICATIONS

This application is based on and hereby claims priority to German Application No. 10056326.0 filed on Nov. 14, 2000 in Germany, the contents of which are hereby incorporated by reference.

### BACKGROUND OF THE INVENTION

The invention relates to a placement element release device for multiple placement element belts, and also to a release system for placement elements.

The technical progress in placement technology has led to the situation in which, with high placement element diversity the placement elements in some instances have ever smaller dimensions and ever higher placement performances are demanded. A multiplicity of placement elements is provided in the meantime in a manner arranged in belts. With placement elements becoming ever smaller, however, there is the problem that placement elements with very small dimensioning are arranged in a belt with predetermined dimensioning which is relatively large with respect to the placement elements that are becoming smaller. As a result, the provision capacity and, consequently, also the placement performance to be achieved are limited.

### SUMMARY OF THE INVENTION

One aspect of the invention is based on the object of providing an apparatus by means of which a larger multiplicity of placement elements can be made available more rapidly during a placement process and, consequently, the placement performance can be increased.

A placement element release device for multiple placement element belts is provided, in which the multiple placement element belts have, transversely with respect to their transport direction, at least two tracks along which placement elements are arranged in openings. In this case, the placement element release device has a transport apparatus, by which at least one multiple placement element belt can be transported in the transport direction and the openings can be positioned in a collection position, so that, in the collection position, a plurality of placement elements corresponding to the number of tracks are arranged next to one another transversely with respect to the transport direction. Furthermore, in the region of the collection position, a screen is arranged, displaceably relative to the placement elements, above the belt in such a way that the placement elements can be covered, and can be released by the screen.

With the above device, it may be possible to reduce the number of conveying apparatuses for the placement element belts by multiple placement element belts being processed by one transport apparatus or conveying apparatus. This makes it possible to considerably reduce the space requirement of the transport apparatus on a placement apparatus. Furthermore, the material of the placement element belt is also utilized better. In the region of the collection position, a screen can be displaced above the placement elements in such a way that the placement elements are either covered by the screen or, by way of example, are released by an opening—provided in the screen—or an edge of the screen. This makes it possible to prevent placement elements from falling from the multiple placement element belt before they have been collected by a handling apparatus for placement for example on a printed circuit board.

The screen may be displaceable transversely with respect to the transport direction. In this case, the screen may, for example, be of tape-like design and have an opening through which the placement elements can be released when the opening of the screen has been brought at least partly into congruence with the opening of the multiple placement element belt. However, the screen may also be of strip-like design and the covering and releasing of the placement elements can be carried out by a terminating edge of the strip-like screen, the terminating edge deviating from the transverse direction of the multiple placement element belt. In this case, only a single placement element of the multiple placement element belt is in each case exposed through displacement of the strip-like screen in the longitudinal direction of the multiple placement element belt.

Furthermore, the inventors propose a release system for placement elements which has the placement element release device described above and also at least one multiple placement element belt. The multiple placement element belt is provided transversely with respect to its transport direction, with at least two tracks in which placement elements are arranged in openings. In the transverse direction of the multiple placement element belt, a plurality of placement elements corresponding to the number of tracks are arranged next to one another. In this case different placement elements may be arranged in the multiple placement element belt. By way of example, it is possible to arrange, in any desired combination, different placement elements in the tracks of the multiple placement element belt. However, each track of the multiple placement element belt may also have the same placement elements.

When the above is used for printed circuit boards with a large number of components to be populated, the number of required feed apparatuses can be greatly reduced since the placement elements provided on the individual feed apparatus with placement element belts can be provided by means of a single multiple placement element belt on a single feed apparatus or transport apparatus. Faster and more reliable operation of a placement apparatus may be possible by virtue of the displaceable screen according to the placement element release device described above or according to the release system for placement elements described above.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1a and 1b show diagrammatic views of a first preferred embodiment of the invention,

FIG. 2 shows a diagrammatic view of a second preferred embodiment of the invention, and

FIGS. 3a and 3b show plan views of multiple placement element belts according to the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

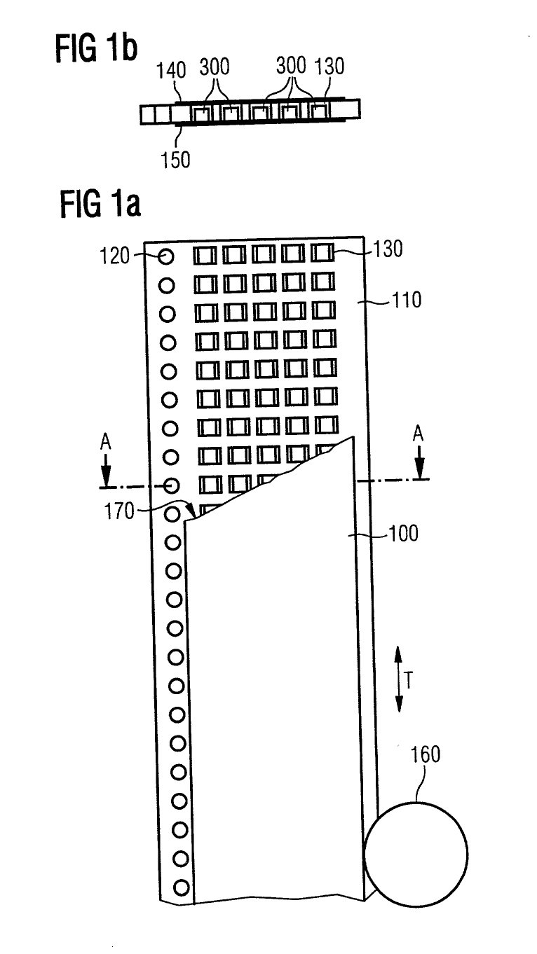

As can be seen from FIGS. 1a and 1b, a first preferred embodiment has a screen 100 arranged in the longitudinal direction of a multiple placement element belt 110. The multiple placement element belt 110 has a plurality of openings 130, in which placement elements 300 can be arranged. On its top side and on its underside, the placement element belt is respectively provided with cover sheets 140 and 150, which prevent the placement elements 300 from falling through the opening 130 of the multiple placement element belt, and at least one of which is removed during the placement process in order that placement elements can be taken from the multiple placement element belt.

Once the covering sheet has been removed, however, there is the risk that the now exposed placement elements will fall from the multiple placement element belt before they have been placed e.g. onto a printed circuit board. The placement elements are therefore covered by a screen until shortly before the point in time at which they are taken from the multiple placement element belt.

The multiple placement element belt 110 furthermore has a plurality of openings 120 running in the longitudinal direction laterally on the multiple placement element belt 110, by which openings the multiple placement element belt 110 can be captured, and positioned, for example by means of a pinned wheel of a transport apparatus. With a drive 160, the screen 100 can be displaced in the transport direction T along the multiple placement element belt 110.

The screen 100 has a terminating edge 170. The terminating edge 170 deviates from the transverse direction of the multiple placement element belt 110. As a result, the terminating edge 170 of the screen 100 runs in such a way that it is possible, through displacement of the screen 100 in the transport direction T, in each case to release a placement element 300 of a plurality of placement elements 300 arranged next to one another in the openings 130 of the multiple placement element belt 110. Such a released placement element 300 can then be taken from the multiple placement element belt 110 by a handling apparatus (not shown), such as a vacuum pipette arrangement, for example. The terminating edge 170 may, for example, be designed with a stepped profile in the transverse direction, the height of the steps being chosen such that it is possible, by the screen 100, for the placement elements to be individually selectively released. The terminating edge 170 may also have a curved or serrated profile or another form which enables the selective release of placement elements arranged next to one another.

As should be apparent, it may be possible to keep ready in a collection position A a plurality of placement elements 300 arranged next to one another in the transport direction T in the multiple placement element belt 110. Through displacement of the screen 100 in the transport direction T by the drive 160, it is possible for the placement elements 300 arranged next to one another to be selectively covered, or released, by the screen 100. By way of example, as can be seen from FIGS. 1a and 1b, five placement elements 300 may be arranged next to one another in the openings 130 of the multiple placement element belt 110. As a result, instead of five individual transport apparatuses for a respective placement element in the transverse direction of the placement element belts, a single transport apparatus can be used for a multiple placement element belt 110 of this type. In the case of such a transport apparatus for a multiple placement element belt 110, the placement element belt would then also not need to be transported further after each removal cycle by a handling device of an automatic placement machine, rather only after the last placement element 300 has been taken from a row of placement elements. This results in a longer service life of the transport apparatus and also a higher cycle rate when removing placement elements.

Moreover, it is also not necessary for the covering sheet to be withdrawn from the multiple placement element belt 110 after each removal cycle of a handling device, such as a suction pipette arrangement. This can likewise be done only after the last placement element 300 from a row of placement elements 300 arranged next to one another in openings of the multiple placement element belt 110 has been removed from the collection position A.

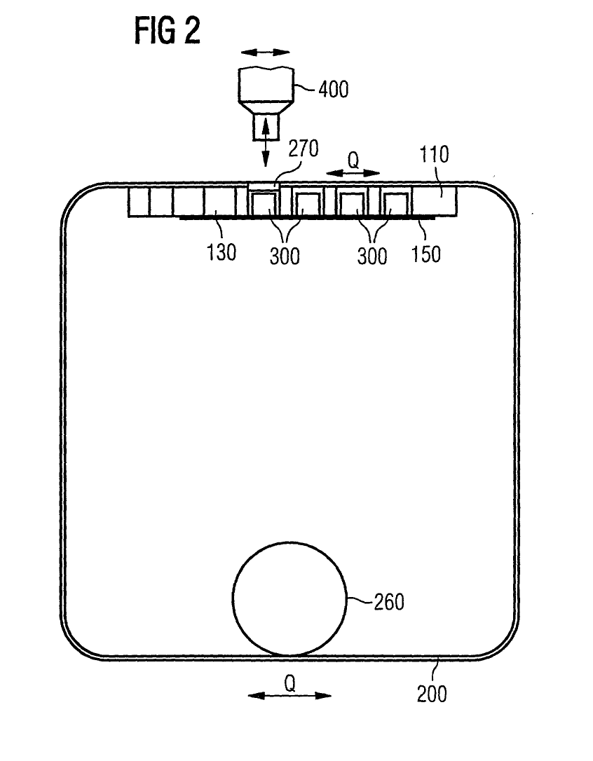

FIG. 2 reveals a second preferred embodiment of the invention. The second preferred embodiment of the invention is used with the same multiple placement element belt 110 as has already been described in the description of the first preferred embodiment with reference to FIGS. 1a and 1b. In the second preferred embodiment, a screen 200 is arranged above the multiple placement element belt 110 in such a way that it can be displaced relative to said belt in the transverse direction Q thereafter. The screen 200 has an opening 270 to which a placement element 300 arranged in the multiple placement element belt 110, in one of the openings 130 thereafter can be removed when the opening 270 of the screen 200 has at least partly been brought into congruence with that opening 130 of the multiple placement element belt 110 from which the placement element 300 is intended to be removed.

For this purpose, for example, a handling apparatus 400 can be used, for example a vacuum pipette arrangement. The screen 200 is coupled to a drive 260, which enables the screen to move in the transverse direction A. The arrangement of the screen 200 in the transverse direction with respect to the multiple placement element belt 110 affords the advantage that the extent of the screen 200 in the longitudinal direction of the multiple placement element belt 110 can be made relatively small, so that a transport apparatus with a relatively small structural length is possible.

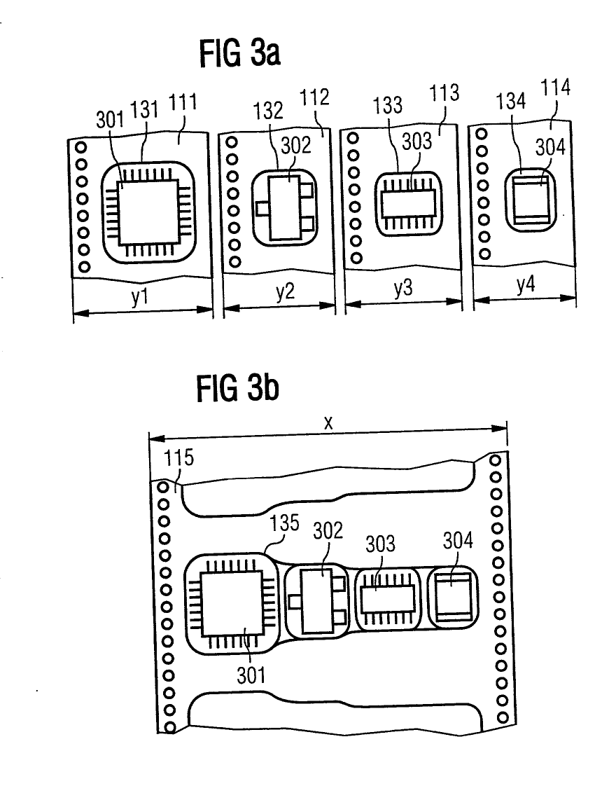

As can be seen from FIGS. 3a and 3b, it may be possible to arrange different placement elements 301, 302, 303, 304 in a multiple placement element belt 115, for example in a common opening 135. In this case, the different placement elements 301, 302, 303, 304 can either be arranged as desired in the multiple placement element belt 115 or the same placement elements can be arranged in a respective track and different placement elements can be arranged (not shown) in the plurality of tracks which can run next to one another along the multiple placement element belt 110.

As can be seen from FIGS. 3a and 3b, this makes it possible to use a single multiple placement element belt 115 to prove a plurality of different placement elements 301, 302, 303, 304 for a placement process, which would have to be provided otherwise in each case in a dedicated placement element belt 111, 112, 113 and 114, respectively, and would have to be driven by a transport apparatus in each case.

With the above configuration, the required number of transport apparatuses may be reduced still further. This leads to a smaller space requirement for the individual transport apparatuses, thereby enabling a greater diversity of placement elements to be simultaneously provided on a placement apparatus.

The invention has been described in detail with particular reference to preferred embodiments thereof and examples, but it will be understood that variations and modifications can be effected within the spirit and scope of the invention.

What is claimed is:

1. A placement element release device for multiple placement element belts which have, transversely with respect to their transport direction, at least two tracks along which placement elements are arranged in openings, the placement element release device comprising:
a transport apparatus, by which at least one multiple placement element belt can be transported in the transport direction and the openings can be positioned in a collection position, so that, in the collection position, a plurality of placement elements corresponding to the number of tracks are arranged next to one another transversely with respect to the transport direction, and wherein
in the region of the collection position, a screen which can be displaced relative to the placement elements is arranged above the multiple placement element belt in such a way that the placements elements can be covered, and can be released, by the screen.

2. The placement element release device as claimed in claim 1, wherein the screen can be displaced transversely with respect to the transport direction.

3. The placement element release device as claimed in claim 1, wherein the screen can be displaced essentially in the transport direction.

4. The placement element release device as claimed in claim 1, wherein the screen is of tape-like design and has an opening for releasing the placement elements.

5. The placement element release device as claimed in claim 2, wherein the screen is of tape-like design and has an opening for releasing the placement elements.

6. The placement element release device as claimed in claim 3, wherein the screen is of tape-like design and has an opening for releasing the placement elements.

7. The placement element release device as claimed in claim 1, wherein the screen is of strip-like design and has a terminating edge for covering and releasing the placement elements, which deviates from the transverse direction of the multiple placement element belt.

8. The placement element release device as claimed in claim 2, wherein the screen is of strip-like design and has a terminating edge for covering and releasing the placement elements, which deviates from the transverse direction of the multiple placement element belt.

9. The placement element release device as claimed in claim 3, wherein the screen is of strip-like design and has a terminating edge for covering and releasing the placement elements, which deviates from the transverse direction of the multiple placement element belt.

10. The placement element release device as claimed in claim 7, wherein the terminating edge is of stepped design.

11. A release system for placement elements comprising:
at least one multiple placement element belt which has, transversely with respect to its transport direction, at least two tracks along which placement elements are arranged in openings,
a transport apparatus, by which the multiple placement element belt can be transported in the transport direction and the openings can be positioned in a collection position, wherein, in the collection position, a plurality of placement elements corresponding to the number of tracks are arranged next to one another transversely with respect to the transport direction, and wherein
in the region of the collection position, a screen which can be displaced relative to the placement elements is arranged above the multiple placement element belt in such a way that the placements elements can be covered, and can be released, by the screen.

12. The release system as claimed in claim 11, wherein the screen can be displaced transversely with respect to the transport direction.

13. The release system as claimed in claim 11, wherein the screen can be displaced essentially in the transport direction.

14. The release system as claimed in claim 11, wherein the screen is of strip-like design and has an opening for releasing the placement elements.

15. The release system as claimed in claim 12, wherein the screen is of strip-like design and has an opening for releasing the placement elements.

16. The release system as claimed in claim 13, wherein the screen is of strip-like design and has an opening for releasing the placement elements.

17. The release system as claimed in claim 11, wherein the screen is of strip-like design and has a terminating edge for covering and releasing the placement elements, which deviates from the transverse direction of the multiple placement element belt.

18. The release system as claimed in claim 17, wherein the terminating edge is of stepped design.

19. The release system as claimed in claim 11, wherein different placement elements are arranged in the multiple placement element belt.

20. The release system as claimed in claim 19, wherein respectively identical placement elements are arranged in each track of the multiple placement element belts.

21. A placement device, comprising:
a moving belt to accommodate multiple placement elements thereon, the placement elements being received in openings provided in the belt, the openings being arranged in tracks on the belt; and
a movable screen selectively arranged above the belt to selectively cover the openings in the moving belt.

22. A placement device according to claim 21, wherein the movable screen has apertures corresponding to the openings in the movable belt, such that the elements are released from the openings by moving the apertures in the movable screen into alignment with the openings in moving belt.

23. A placement device according to claim 21, wherein different placement elements are arranged in the openings of different tracks.

24. A placement device according to claim 21, wherein the elements are circuit board components.

25. A placement device according to claim 21, further comprising a handling apparatus to remove the elements from the opening when the openings are not covered by the screen.
